(19) United States
(12) Patent Application Publication
(10) Pub. No.: US 2015/0285201 A1
(43) Pub. Date: Oct. 8, 2015

(54) FUEL INJECTOR

(71) Applicant: DENSO CORPORATION, Kariya-city (JP)

(72) Inventors: Kazufumi SERIZAWA, Obu-city (JP); Masayuki SUZUKI, Toyota-city (JP); Koji ISHIZUKA, Chita-gun (JP)

(21) Appl. No.: 14/658,697

(22) Filed: Mar. 16, 2015

(30) Foreign Application Priority Data
Apr. 7, 2014 (JP) 2014-78792

(51) Int. Cl. F02M 61/18; F02M 61/14

(52) U.S. Cl. CPC F02M 61/182; F02M 61/14

(57) ABSTRACT

An injection port includes a straightening area which straightens a flow of a fuel, and an increasing area which is a slit connected to a downstream end of the straightening area and increasing a cross-sectional area of the flow toward a downstream end of the increasing area. The fuel is injected from the downstream end of the increasing area. When a cross-sectional area of the downstream end of the straightening area is expressed as S1, a cross-sectional area of the downstream end of the increasing area is expressed as S2, and a shape property value is expressed as X that is equal to S2/S1, the shape property value X is set to be greater than 1.0 and be less than or equal to 4.0.

### CROSS REFERENCE TO RELATED APPLICATION

This application is based on Japanese Patent Application No. 2014-78792 filed on Apr. 7, 2014, the disclosure of which is incorporated herein by reference.

### TECHNICAL FIELD

The present disclosure relates to a fuel injector injecting fuel into a combustion chamber of an internal combustion engine.

### BACKGROUND

Conventionally, a first fuel injector has an inner diameter that is constant, or the first fuel injector is a truncated conical shape having a diameter decreasing toward a downstream of a fuel.

Alternatively, according to JP-2005-131539A, a second fuel injector includes an injection port having an inner wall surface provided with a protrusion part that is a spiral shape. A fuel flowing through the injection port becomes an eddy fuel and is injected to be a spray having a larger spray width.

However, since a spray width of a spray of a fuel injected from the first fuel injector is small, the fuel is difficultly spread to be filled with a combustion chamber. Therefore, a variation of an air-fuel equivalence ratio in the combustion chamber is deteriorated. Further, since the spray width is small, a penetrating force of the spray is large. Therefore, the spray is collided with a wall surface of the combustion chamber to be cooled down, and a heat efficiency is deteriorated.

Since the eddy fuel is injected from the second fuel injector, an air in the combustion chamber is readily mixed with the eddy fuel in the spray in the vicinity of an outer edge of the spray to become a lean air-fuel mixture. Further, since it is difficult that the air in the combustion chamber is mixed with the eddy fuel in the spray in the vicinity of a center of the spray, the air and the eddy fuel become a rich air-fuel mixture. Therefore, a variation of an air-fuel equivalence ratio in the combustion chamber is deteriorated.

### SUMMARY

The present disclosure is made in view of the above matters, and it is an object of the present disclosure to provide a fuel injector which can suppress a variation of an air-fuel equivalence ratio by suppressing a variation of a particle diameter of a spray and can obtain a large spray width.

According to an aspect of the present disclosure, a fuel injector includes a nozzle body and a nozzle needle. The nozzle body includes an injection port injecting a fuel into a combustion chamber of an internal combustion engine. The nozzle needle is slidable relative to the nozzle body along a center axis of the nozzle body to open or close the injection port. The injection port includes a straightening area which straightens a flow of the fuel, and an increasing area which is a slit connected to a downstream end of the straightening area and increasing a cross-sectional area of the flow toward a downstream end of the increasing area. The fuel is injected from the downstream end of the increasing area. When a cross-sectional area of the downstream end of the straightening area is expressed as S1, a cross-sectional area of the downstream end of the increasing area is expressed as S2, and a shape property value is expressed as X that is equal to S1/S2, the shape property value X is set to be greater than 1.0 and be less than or equal to 4.0.

Therefore, the fuel injector can suppress a variation of an air-fuel equivalence ratio and can obtain a large spray width.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a front view showing an internal combustion engine provided with a fuel injector, according to a first embodiment of the present disclosure;

FIG. 2 is a front view showing the fuel injector of FIG. 1;

FIG. 3 is an enlarged view of an area III of FIG. 2;

FIG. 4 is a cross-sectional view taken along an arrow IV of FIG. 3;

FIG. 5 is a diagram showing a shape of a spray of a fuel injector according to a conventional example;

FIG. 6 is a diagram showing a shape of a spray of the fuel injector according to the first embodiment;

FIG. 7 is a diagram showing a spray property of the fuel injector according to the first embodiment;

FIG. 8 is a diagram showing a shape of an injection port of the fuel injector according to a second embodiment of the present disclosure; and

FIG. 9 is a cross-sectional view taken along a line IX-IX of FIG. 8.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, referring to drawings, an embodiment of the present invention will be described. In addition, the substantially same parts and components are indicated with the same reference numeral in following embodiments.

### First Embodiment

A first embodiment of the present disclosure will be described.

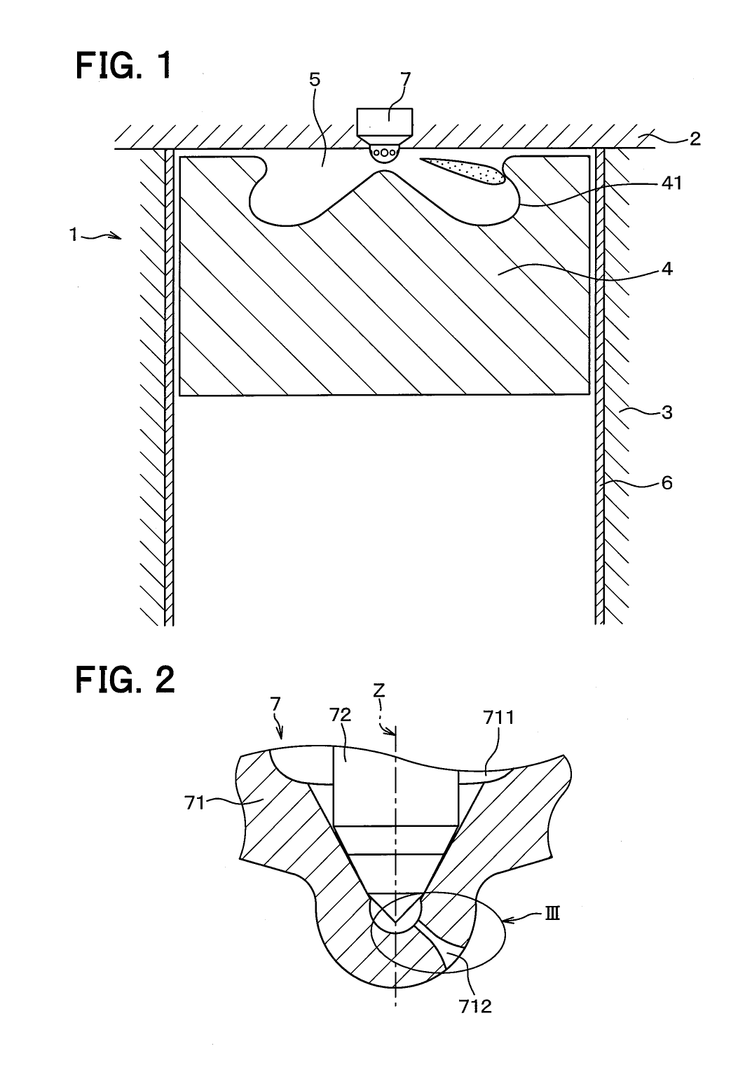

As shown in FIG. 1, an internal combustion engine 1 includes a cylinder head 2, a cylinder block 3, and a piston 4, which form a combustion chamber 5. According to the present embodiment, the internal combustion engine 1 is a compression ignition-type internal combustion engine.

An inner peripheral portion of the cylinder block 3 is provided with a cylinder liner 6. A top portion of the piston 4 is provided with a cavity 41 which is a part of the combustion chamber 5.

A fuel injector 7 is placed at a position of the cylinder head 2 adjacent to a center axis of the combustion chamber 5. The fuel injector 7 is connected to a common rail (not shown) that accumulates a high-pressure fuel, and injects the high-pressure fuel into the combustion chamber 5. Specifically, the fuel injector 7 injects the high-pressure fuel supplied from the common rail into the cavity 41.

As shown in FIG. 2, the fuel injector 7 includes a nozzle body 71 that is a substantially cylindrical shape, and a nozzle needle 72 that is a substantially columnar shape.

The nozzle body 71 includes a high-pressure fuel passage 711 and an injection port 712. The high-pressure fuel passage 711 is a passage of the high-pressure fuel supplied from the common rail. The injection port 712 is placed downstream of the high-pressure fuel passage 711. The fuel injector 7 injects the high-pressure fuel into the combustion chamber 5 of the internal combustion engine 1 through the injection port 712. According to the present embodiment, plural injection ports 712 are placed along a circumferential direction of the nozzle body 71. Specifically, four injection ports 712 are provided. A spray of each injection port 712 is a radial shape.

The nozzle needle 72 is provided in the nozzle body 71, and is slidably moved along a center axis z of the nozzle body 71 to open or close the injection port 712.

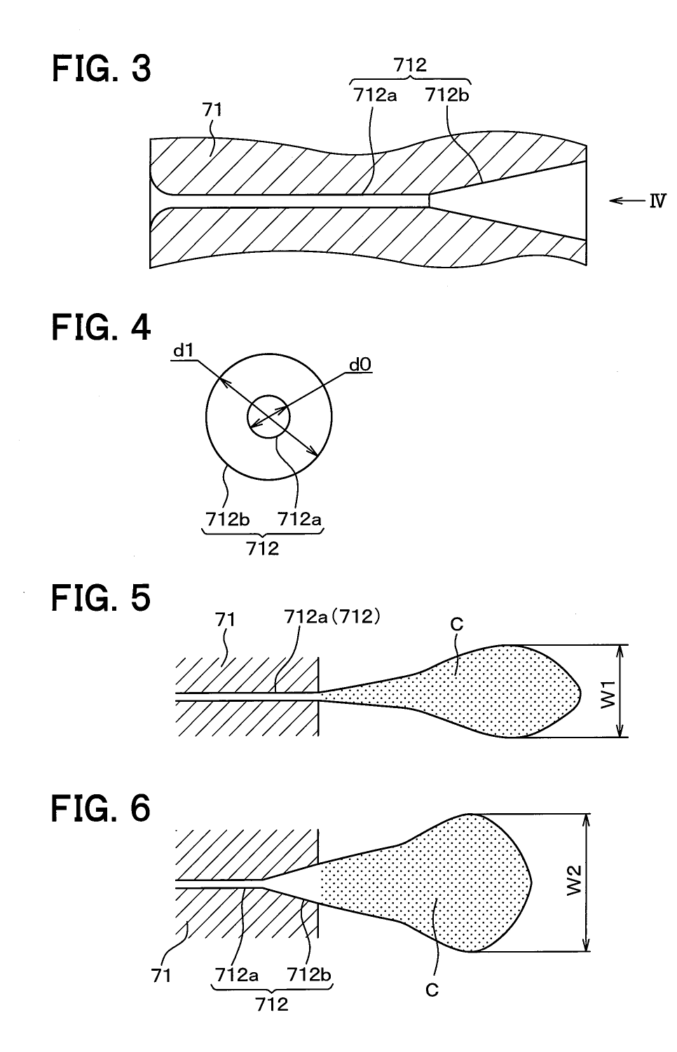

As shown in FIGS. 3 and 4, the injection port 712 includes a straightening area 712a which straightens a flow of the high-pressure fuel, and an increasing area 712b which is a slit connected to a downstream end of the straightening area 712a and increasing a cross-sectional area of the flow toward a downstream end of the increasing area 712b. The high-pressure fuel is injected from the downstream end of the increasing area 712b. According to the present embodiment, the downstream end of the increasing area 712b is a fuel injection portion.

The straightening area 712a is a round shape in a cross-sectional surface of the flow, and the cross-sectional area of the flow in the straightening area 712a is constant. The straightening area 712a is concentric with the increasing area 712b.

The increasing area 712b is a round shape in a cross-sectional surface of the flow, and is a truncated conical shape having a diameter increasing by a constant rate toward the downstream of the increasing area 712b.

A most outer peripheral part of the high-pressure fuel flowing through the increasing area 712b flows along a wall surface of the increasing area 712b. Therefore, the high-pressure fuel is spread in the increasing area 712b while flows through the increasing area 712b, and the spray in the combustion chamber 5 is widely spread.

A cross-sectional area of the downstream end of the straightening area 712a is referred to as S1, a cross-sectional area of the downstream end of the increasing area 712b is referred to as S2, and the cross-sectional area S2 divided by the cross-sectional area S1 is referred to as a shape property value X. Further, a diameter of the downstream end of the straightening area 712a is referred to as d0, and a diameter of the downstream end of the increasing area 712b is referred to as d1. The cross-sectional area S1 and the cross-sectional area S2 can be calculated by using formulas (1) and (2).

S1=π/4×d0² (1)

S2=π/4×d1² (2)

As shown in FIG. 5, in a fuel injector according to a conventional example, the injection port 712 only includes the straightening area 712a. Therefore, when 1 ms has elapsed after a fuel injection of the fuel injector is started, a spray C has the maximum spray width W1. As shown in FIG. 6, in the fuel injector 7 according to the present embodiment, the injection port 712 includes the straightening area 712a and the increasing area 712b. Therefore, when 1 ms has elapsed after a fuel injection of the fuel injector 7 is started, a spray C has the maximum spray width W2. The maximum spray width W2 divided by the maximum spray width W1 is referred to as a spray width reference Rw.

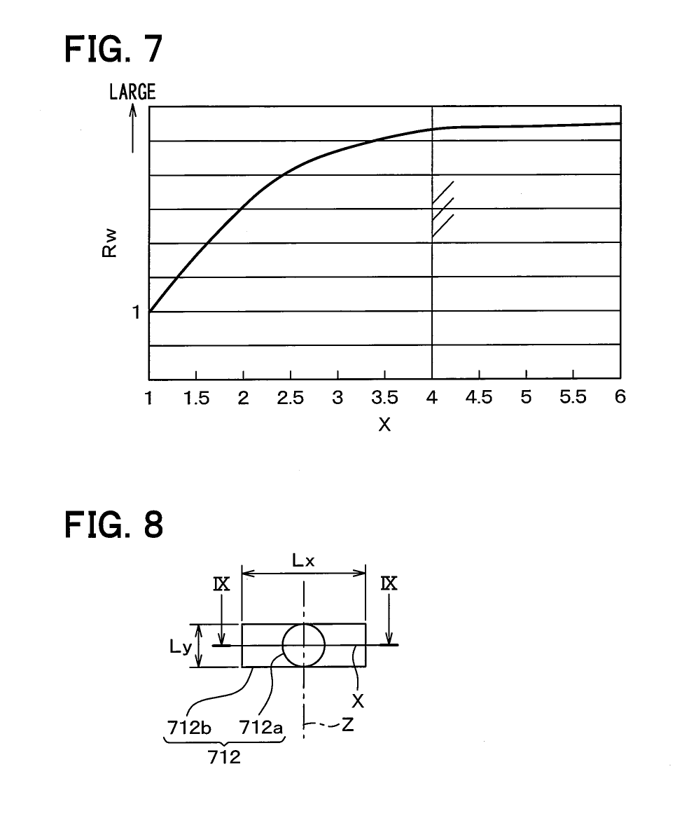

As shown in FIG. 7, in an area where the shape property value X is greater than 1.0, the spray width reference Rw is greater than 1. In this case, the maximum spray width W2 of the fuel injector 7 according to the present embodiment is greater than the maximum spray width W1 of the fuel injector according to the conventional example.

In an area where the shape property value X is greater than 1.0 and is less than or equal to 4.0, the spray width reference Rw increases in accordance with an increase in shape property value X. In an area where the shape property value X is greater than 4.0, the spray width reference Rw hardly increases in accordance with the increase in shape property value X.

A variation of an air-fuel equivalence ratio of the spray decreases in accordance with the increase in shape property value X.

In the area where the shape property value X is greater than 4.0, the spray width reference Rw hardly increases in accordance with the increase in shape property value X. In this case, a separation of flow is generated in the increasing area 712b. In other words, since a variation of a particle diameter of the spray is deteriorated and a variation of the air-fuel equivalence ratio of the spray is deteriorated, it is unnecessary that the area where the shape property value X is greater than 4.0 is used. Since the area where the shape property value X is greater than 1.0 and is less than or equal to 4.0 is used, the variation of the air-fuel equivalence ratio of the spray is suppressed and a larger spray width can be obtained.

Considering a processing accuracy of the injection port 712, it is preferable that the shape property value X is greater than or equal to 1.2 such that a larger spray width can be surely obtained.

According to the present embodiment, since the area where the shape property value X is greater than 1.0 and is less than or equal to 4.0 is used, the variation of the air-fuel equivalence ratio of the spray is suppressed and a larger spray width can be obtained. Therefore, a homogeneous air-fuel mixture can be filled with the combustion chamber 5, a heat efficiency can be improved, and an emission can be suppressed.

Since a penetrating force of the spray decreases in accordance with an increase in spray width of the spray, it is suppressed that the spray collides with a wall surface of the combustion chamber 5 to be cooled down. Further, the heat efficiency can be improved.

Since the straightening area 712a is a round shape in the cross-sectional surface of the flow and the cross-sectional area of the flow in the straightening area 712a is constant, a processing of the straightening area 712a is simplified.

Since the straightening area 712a is concentric with the increasing area 712b, when the high-pressure fuel flows from the straightening area 712a to the increasing area 712b, the high-pressure fuel is homogeneously spread in the increasing area 712b. Therefore, the variation of the air-fuel equivalence ratio of the spray is further suppressed.

According to the embodiment, the increasing area 712b is a round shape in the cross-sectional surface of the flow and is a truncated conical shape having a diameter increasing by a constant rate toward the downstream of the increasing area 712b. However, the increasing area 712b may be a round shape in the cross-sectional surface of the flow and is a wrapper shape having a diameter sharply increasing toward the downstream end of the increasing area 712b.

### Second Embodiment

A second embodiment of the present disclosure will be described. According to the present embodiment, a configuration of the increasing area 712b in the first embodiment is changed. Other members of the present embodiment are as the same as those in the first embodiment. Therefore, only the above different parts of the present embodiment will be described.

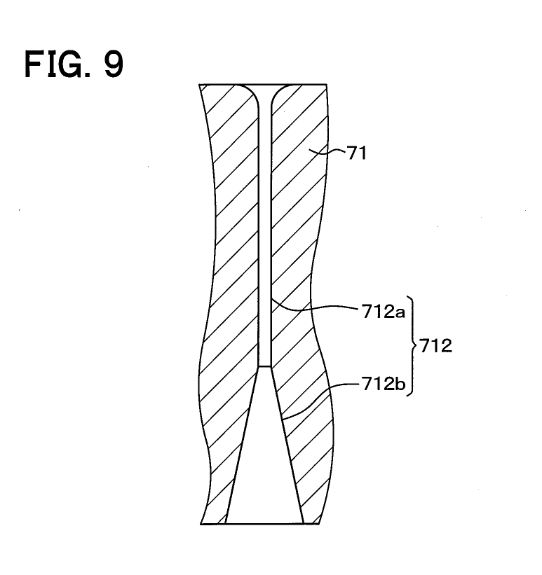

As shown in FIGS. 8 and 9, the increasing area 712b is a slit having a downstream end that is a rectangular shape in a cross-sectional surface of the flow. Specifically, the increasing area 712b has a long edge and a short edge. The short edge has a width that is constant, and the long edge has a length increasing by a constant rate toward the downstream end of the increasing area 712b.

A width of the downstream end of the increasing area 712b referred to as Ly is equal to the diameter d0 of the straightening area 712a, and a length of the downstream end of the increasing area 712b referred to as Lx is greater than the diameter d0 of the straightening area 712a. A cross-sectional area of the downstream end of the increasing area 712b is referred to as S2. The cross-sectional area S2 can be calculated by using a formula (3).

S2=Lx×Ly (3)

The increasing area 712b has a corner portion provided with a curved surface having a constant curvature radius R, and the increasing area 712b can be readily processed. The constant curvature radius R is set to be less than a half of the width Ly.

The slit has a longitudinal axis x that is parallel to the long edge of the increasing area 712b. The longitudinal axis x crosses with the center axis z at right angles. In other words, a cross angle between the longitudinal axis x and the center axis z is 90 degrees.

According to the above configuration, the high-pressure fuel flowing through the increasing area 712b is spread in a direction parallel to the long edge of the increasing area 712b, and the spray in the combustion chamber 5 is widely spread. The spray is widely spread in a direction perpendicular to the center axis z of the nozzle body 71.

According to the present embodiment, the effects as the same as the first embodiment can be obtained.

A spread direction of the spray can be regulated by changing the cross angle in a range from 0 degrees to 90 degrees. For example, the cross angle can be set according to a shape of the combustion chamber 5.

According to the present embodiment, the increasing area 712b is a slit that is a rectangular shape. However, the increasing area 712b may be a slit that is a square shape or an elliptical shape.

### Other Embodiment

According to the above embodiments, the present disclosure is applied to the fuel injector of the compression ignition-type internal combustion engine. However, the present disclosure can be applied to a fuel injector of a gasoline direct injection type internal combustion engine.

According to the above embodiments, the cross-sectional area of the straightening area 712a is constant. However, the straightening area 712a may be a truncated conical shape having a diameter decreasing toward the downstream end of the straightening area 712a. In this case, the high-pressure fuel readily smoothly flows from a sack portion to the straightening area 712a. In other words, a flow coefficient becomes larger, and a flow quantity of the high-pressure fuel is increased.

The present disclosure is not limited to the embodiment mentioned above, and can be applied to various embodiments within the spirit and scope of claims of the present disclosure.

The present invention is not limited to the embodiments mentioned above, and can change to various embodiments within the spirit and scope of the present invention.

According to the above embodiments, elements for constituting the above embodiments are not necessary except the element is clearly essential.

According to the above embodiments, a value is used for describing a number of the element, a value of the element, an amount of the element, or a range of the element is not limited to a specified value except this value is clearly essential.

According to the above embodiments, a shape of the element or a relationship between the elements is not limited except a specified shape of the element or a specified relationship between the elements is clearly essential.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fuel injector comprising:
a nozzle body including an injection port injecting a fuel into a combustion chamber of an internal combustion engine;
a nozzle needle being slidable relative to the nozzle body along a center axis of the nozzle body to open or close the injection port, wherein
the injection port includes a straightening area which straightens a flow of the fuel, and an increasing area which is a slit connected to a downstream end of the straightening area and increases a cross-sectional area of the flow toward a downstream end of the increasing area, the fuel being injected from the downstream end of the increasing area, and
when a cross-sectional area of the downstream end of the straightening area is expressed as S1, a cross-sectional area of the downstream end of the increasing area is expressed as S2, and a shape property value is expressed as X that is equal to S2/S1, the shape property value X is set to be greater than 1.0 and be less than or equal to 4.0.

2. The fuel injector according to claim 1, wherein
the straightening area is concentric with the increasing area.

3. The fuel injector according to claim 1, wherein
the increasing area is a truncated conical shape.

4. The fuel injector according to claim 1, wherein
the increasing area is a slit that is a rectangular shape, a square shape, or an elliptical shape.

5. The fuel injector according to claim 4, wherein
a cross angle between a longitudinal axis of the slit and the center axis of the nozzle body is in a range from 0 degrees to 90 degrees.

6. The fuel injector according to claim 1, wherein
the straightening area is a round shape in a cross-sectional surface of the flow, and
the cross-sectional area of the flow in the straightening area is constant.

7. The fuel injector according to claim 1, wherein
the straightening area is a truncated conical shape having a diameter decreasing toward the downstream end of the straightening area.
